(19) United States
(12) Patent Application Publication
(10) Pub. No.: US 2026/0025466 A1
(43) Pub. Date: Jan. 22, 2026

(54) AUTHENTICATION SECURITY FOR INTERFACING WITH INCOMING COMMUNICATIONS AT AN ELECTRONIC DEVICE

(71) Applicant: MOTOROLA MOBILITY LLC, WILMINGTON, DE (US)

(72) Inventors: RANJEET GUPTA, AURORA, IL (US); AJIT KUMAR PANDA, VERNON HILLS, IL (US); DANIEL C CHISU, FRANKLIN PARK, IL (US)

(21) Appl. No.: 18/774,788

(22) Filed: Jul. 16, 2024

(51) Int. Cl. H04M 7/00; H04L 9/40; H04W 4/14

(52) U.S. Cl. CPC H04M 7/0078; H04L 63/083; H04W 4/14

(57) ABSTRACT

An electronic device, a method, and a computer program product for authenticating a user before granting access to at least one incoming communication. The method includes detecting a trigger indicative of an incoming communication being received by the electronic device. In response to detecting the trigger, the method includes identifying if the incoming communication is a secure communication that requires authentication before access is granted. In response to identifying that the incoming communication is a secure communication that requires authentication before access is granted, the method includes disabling access to the incoming communication and presenting a prompt for entry of an authentication input. In response to receiving the authentication input, the method includes determining if the received authentication input matches reference authentication data. In response to determining that the authentication input matches the reference authentication data, the method includes enabling access to the incoming communication.

### BACKGROUND

### 1. Technical Field

The present disclosure generally relates to electronic devices and in particular to protecting electronic devices from unwanted or unauthorized access.

### 2. Description of the Related Art

Electronic devices, such as mobile phones, tablets, and laptops, are widely used for video, voice, and text communication and for data transmission. Electronic devices can receive a variety of communications such as phone calls, video calls, voice over internet protocol (VOIP) calls and text messages. Unfortunately, the received communications can be accessed by an unauthorized user. When a phone call or VOIP call or other communication is received by an electronic device, the call can be answered by an unauthorized user and the unauthorized user can gain access to contents of the call/communication.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 in communication with a computer system and a second electronic device, according to one or more embodiments;

FIG. 3 is a block diagram of example contents of the system memory of the example electronic device of FIG. 1 configured to complete the various processes described herein, according to one or more embodiments;

FIG. 4A is an example illustration of a display of an electronic device presenting an incoming call graphical user interface (GUI) that includes an example incoming call notification and a prompt for entry of an authentication input, according to one or more embodiments;

FIG. 4B is an example illustration of a display of an electronic device presenting an authentication GUI that includes an example passcode entry window, according to one or more embodiments;

FIG. 4C is an example illustration of a display of an electronic device presenting a call GUI that includes an example dial-pad, according to one or more embodiments;

FIG. 5 is an example illustration of a smart speaker presenting an incoming call and an audio prompt for entry of an authentication input, according to one or more embodiments;

FIG. 6A is an example illustration of a display of an electronic device presenting an incoming message GUI that includes an example incoming message notification and prompt for entry of an authentication input, according to one or more embodiments;

FIG. 6B is an example illustration of a display of an electronic device presenting an authentication GUI that includes an example passcode entry window, according to one or more embodiments;

FIG. 6C is an example illustration of a display of an electronic device presenting a message GUI that includes a message, according to one or more embodiments;

FIG. 7 depicts a flowchart of a method by which an electronic device determines that an incoming call requires authentication before access is enabled to the incoming call, according to one or more embodiments; and

FIG. 8 depicts a flowchart of a method by which an electronic device determines that an incoming voice over internet protocol (VOIP) call requires authentication before access is enabled to the incoming VOIP call, according to one or more embodiments; and

FIG. 9 depicts a flowchart of a method by which an electronic device determines that an incoming message requires authentication before access is enabled to the incoming message, according to one or more embodiments.

### DETAILED DESCRIPTION

According to one or more aspects of the disclosure, the illustrative embodiments provide an electronic device, a method, and a computer program product for authenticating a user before granting access to at least one incoming communication. In a first embodiment, an electronic device includes a communications subsystem, a memory having stored thereon a security module for configuring the electronic device to perform authentication of a user before access is granted to at least one incoming communication, and at least one processor communicatively coupled to the communications subsystem and the memory. The at least one processor executes program code of the security module, and is configured to cause the electronic device to detect a trigger indicative of the at least one incoming communication being received by the electronic device. In response to detecting the trigger, the at least one processor identifies if the at least one incoming communication is a secure communication that requires authentication before access is granted to the at least one incoming communication. In response to identifying that the at least one incoming communication is a secure communication that requires authentication before access is granted, the at least one processor disables access to the at least one incoming communication and generates and presents a prompt for entry of an authentication input. In response to entry of the authentication input, the at least one processor determines if a received authentication input substantially matches a reference authentication input. In response to determining that the received authentication input substantially matches the reference authentication input, the at least one processor enables access to the at least one incoming communication.

According to another embodiment, the method includes detecting, via at least one processor of an electronic device, a trigger indicative of the at least one incoming communication being received by the electronic device. In response to detecting the trigger, the method includes identifying if the at least one incoming communication is a secure communication that requires authentication before access is granted to the at least one incoming communication. In response to identifying that the at least one incoming communication is a secure communication that requires authentication before access is granted, the method includes disabling access to the at least one incoming communication and generating and presenting a prompt for entry of an authentication input. In response to entry of the authentication input, the method includes determining if a received authentication input substantially matches a reference authentication input. In response to determining that the received authentication input substantially matches the reference authentication input, the method includes enabling access to the at least one incoming communication.

According to an additional embodiment, a computer program product includes a computer readable storage device having stored thereon program code that, when executed by at least one processor of an electronic device having a communications subsystem, the program code configures the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

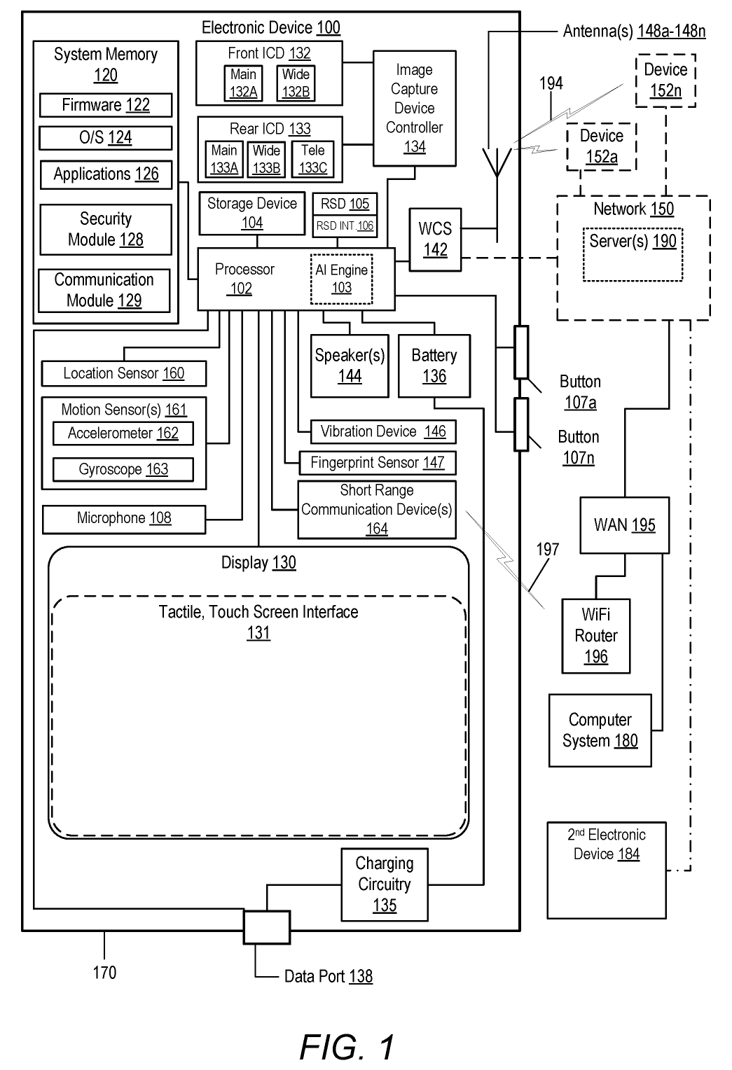

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 103. AI engine 103 accelerates artificial intelligence, natural language processing (NLP), context evaluation (CE), and machine learning applications. AI engine 103 can also be implemented as a software module executed by processor 102, in one embodiment.

System memory 120 may be a combination of volatile and non-volatile memory, such as random access memory (RAM) and read-only memory (ROM). System memory 120 can store program code and data associated with firmware 122, an operating system 124, applications 126, security module 128, and communication module 129. Security module 128 includes program code that is executable by processor 102 to configure electronic device 100 to perform the functions of authenticating a user before access is granted to certain types of incoming communications. Communication module 129 includes program code that is executed by processor 102 to enable electronic device 100 to communicate with other external devices and systems.

Although depicted as being separate from applications 126, security module 128 and communication module 129 may each be implemented as an application. Processor 102 loads and executes program code stored in system memory 120, including program code associated with applications 126 and program code associated with security module 128 and communication module 129. When processed/executed by processor 102, the program code causes or configures processor 102 and/or electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of security module 128 stored thereon, in addition to other program code. Processor 102 can access RSD 105 to provision electronic device 100 with program code that, when executed by processor 102, the program code causes or configures processor 102 and/or electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device. In one embodiment, electronic device 100 can be a smart speaker where display 130 is omitted from electronic device 100.

Throughout the disclosure, the term image capturing device is utilized interchangeably to be synonymous with and/or refer to any one of front or rear cameras 132, 133. As illustrated, electronic device 100 includes several front cameras 132. Electronic device 100 further includes several rear cameras 133. Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B, and 133C. In one or more embodiments, one or more of front and rear cameras 132, 133 can operate to capture a face of a user to be used as an authentication input in response to a request for user authentication to enable access to a received communication.

Electronic device 100 can further include charging circuitry 135, battery 136, and data port 138, for providing electrical power to the various electronic components of electronic device 100. Data port 138 also operates as a physical communication interface allowing electronic device to be communicatively coupled to a second device or component via a micro-USB (universal serial bus) connection. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to audibly receive biometric data to identify or authenticate a user. Microphone 108 and input buttons 107a-n can also be referred to generally as input devices. Speaker 144 can provide an audio alert to a user. In one embodiment, an audio alert can be presented to a user on speaker 144 comprising a prompt for entry of an authentication input. The authentication input can be a spoken or audio authentication input that is received via microphone 108.

Electronic device 100 further includes wireless communication system (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. WCS 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with computer system 180, and second electronic device 184. Computer system 180 is communicatively coupled to wireless network 150 by a wide area network (WAN) 195, such as the Internet. In an embodiment, servers 190 of wireless network 150 support wireless exchange of e-mail, text, data, and other communications between electronic device 100 and computer system 180. In one embodiment, computer system 180 and/or second electronic device 184 can provide communications including text, data and information that are transmitted to and received by electronic device 100.

Second electronic device 184 is also communicatively coupled to wireless network 150. Second electronic device 184 can be similarly connected to wireless network 150, via one of network communication devices 152a-152n. In an embodiment, servers 190 of wireless network 150 support wireless exchange of voice, text, data, and video and other communication between electronic device 100 and second electronic device 184. In one embodiment, second electronic device 184 can originate and provide communications including text, data and information that are transmitted to and received by electronic device 100. While electronic device 100 is shown in communication via wireless network 150 with one other electronic device, electronic device 100 can be in communication with more than one electronic device.

Electronic device 100 further includes short range communication device(s) 164. Short-range communication device(s) 164 includes one or more low powered transceiver(s) that can wirelessly communicate with other devices, such as WiFi router 196. In one embodiment, electronic device 100 can communicate with WiFi router 196 wirelessly via short-range communication device(s) 164. Electronic device 100 can connect wirelessly to wireless network 150 via communication signals 197 transmitted by short-range communication device(s) 164 to and from WiFi router 196, which is communicatively coupled to WAN 195, such as the Internet, which, in turn, is communicatively coupled to wireless network 150.

Short-range communication device(s) 164 can wirelessly communicate with WiFi router 196 via communication signals 197. In one embodiment, electronic device 100 can receive voice over internet protocol (VOIP) or Wi-Fi based calls via short-range communication device(s) 164. In an embodiment, WCS 142, antennas 148a-148n and short-range communication device(s) 164 collectively provide communication interface(s) of a communications subsystem of electronic device 100.

Electronic device 100 further includes vibration device 146, fingerprint sensor 147, location sensor 160, and motion sensor(s) 161. Vibration device 146 can cause electronic device 100 to vibrate or shake when activated. Vibration device 146 can be activated to provide an alert or notification to a user of electronic device 100 when a received communication requires user authentication to be provided. According to one aspect of the disclosure, display 130, speakers 144, and vibration device 146 can generally and collectively be referred to as output devices. These output devices can be each utilized to present the different alerts to the user.

Fingerprint sensor 147 can be used to provide biometric data to identify or authenticate a user. Location sensor 160 can provide time data and location data about the physical location of electronic device 100. In one embodiment, location sensor 160 can be a global positioning system (GPS) interface/receiver that uses data received from geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure. Similar or same components are presented with the same leading reference number.

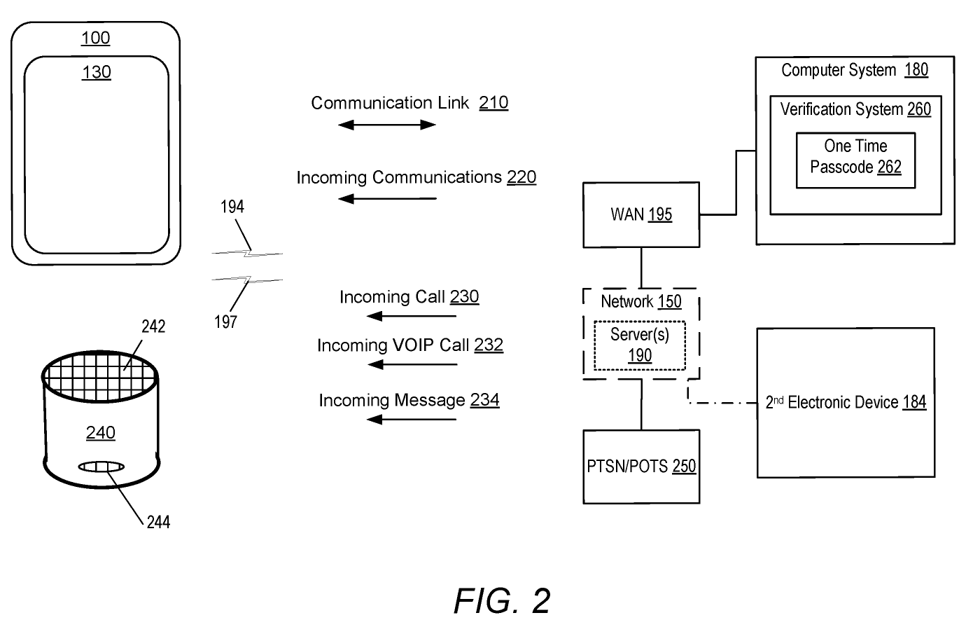

Turning to FIG. 2, with ongoing reference to FIG. 1, electronic device 100 and smart speaker 240 are shown in communication with computer system 180 and second electronic device 184 via at least one communication link 210. In one embodiment, smart speaker 240 can have some similar components to the components of electronic device 100 except that display 130 is omitted and speaker 242 has been added. Smart speaker 240 includes microphone 244. In one embodiment, smart speaker 240 can include a version of security module 128 that includes program code, which is executable by a processor to configure smart speaker 240 to authenticate a user before access is granted to incoming communications. Computer system 180 includes a verification system 260 that can transmit or send a one-time passcode (OTP) 262. In one embodiment, computer system 180 can be a banking computer system that sends OTP 262 as a phone call or as a text message to a user device in response to an attempt by the user to access the banking computer system.

Electronic device 100 and smart speaker 240 can communicate with wireless network 150 and WAN 195 via communication link 210. Electronic device 100 and smart speaker 240 can communicate wirelessly with computer system 180 and second electronic device 184, via wireless network 150 and WAN 195, via transmission and reception of communication signals 194. Communication network 150 includes communication servers 190 that are communicatively connected to a larger, wide area network (WAN) 195, such as the Internet.

Communication servers 190 of communication network 150can also be communicatively connected with other networks and systems including a public switched telephone network (PTSN)/plain old telephone system (POTS) 250. PTSN/POTS 250 can send and receive phone calls to electronic device 100 via wireless network 150. In an embodiment, servers 190 of wireless network 150 support wireless exchange of e-mail, text, messages, data, video and other communications between electronic device 100 and computer system 180 and second electronic device 184.

Electronic device 100 and smart speaker 240 can also establish communication link 210 with wireless network 150 and with WAN 195 via WiFi router 196 and short-range communication device(s) 164 (FIG. 1).

Electronic device 100 and smart speaker 240 can receive incoming communications 220 via communication link 210. The incoming communications 220 can comprise several different types of communications including incoming call 230, incoming VOIP call 232, and incoming message 234. Incoming call 230 is a voice phone call that is received by electronic device 100 and/or smart speaker 240. In one embodiment, incoming call 230 can originate from computer system 180, second electronic device 184, or PTSN/POTS 250, or other connected electronic devices. In one embodiment, incoming call 230 can include a call providing an OTP 262 from computer system 180. In one embodiment, incoming communications 220 can be a secure communication that is intended only for an authorized recipient and is not intended to be accessed by an unauthorized user. For example, in one embodiment, incoming call 230 or incoming message 234 can contain an OTP 262 that is used to access a financial account such as a bank account or a credit card account.

Incoming VOIP call 232 is a voice and/or video call for the delivery of voice and/or communication sessions over Internet Protocol (IP) networks such as the Internet. Incoming VOIP call 232 can be received by electronic device 100 and/or smart speaker 240. In an embodiment, incoming VOIP call 232 can originate from computer system 180, or second electronic device 184 or other connected electronic devices. In one embodiment, incoming VOIP call 232 can include a VOIP call providing an OTP 262 from computer system 180.

In an embodiment, incoming message 234 is a text message comprising alpha numeric characters. In one embodiment, incoming message 234 is a message sent using the protocols of the Short Message Service (SMS). Incoming message 234 can be received by electronic device 100 and/or smart speaker 240. In one embodiment, incoming message 234 can be spoken as audio by smart speaker 240 using a text to voice converter. In an embodiment, incoming message 234 can originate from computer system 180, or second electronic device 184, or other connected electronic devices. In one embodiment, incoming message 234 can include OTP 262 from computer system 180.

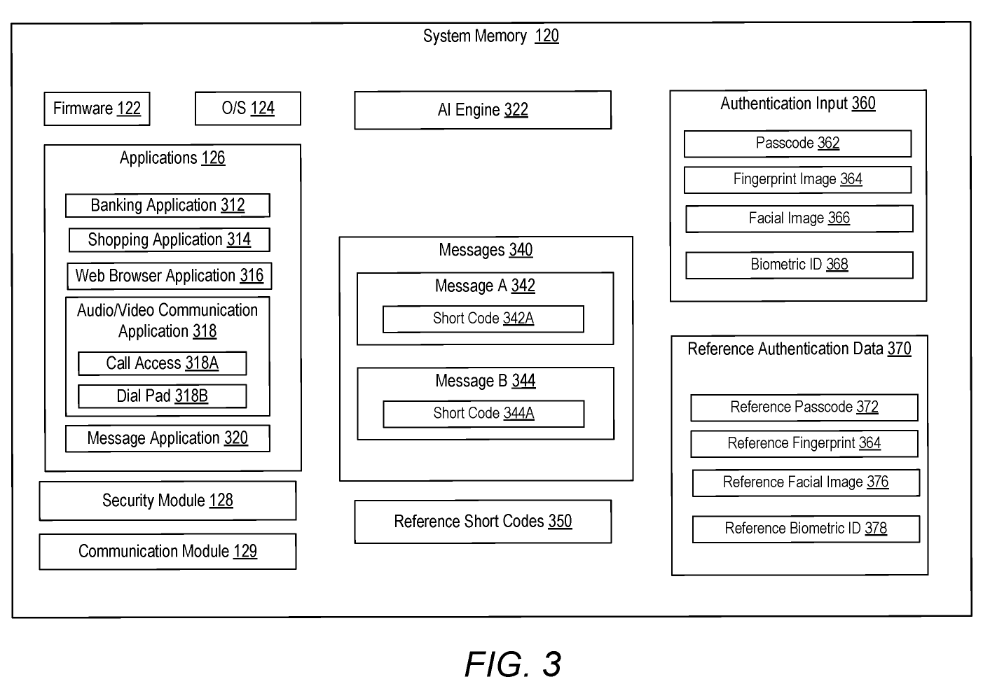

Referring to FIG. 3, there is shown one embodiment of example contents of system memory 120 of electronic device 100 configured to complete the various processes described herein. System memory 120 includes data, software, and/or firmware modules, including firmware 122, an operating system (O/S) 124, applications 126, security module 128, communication module 129, and artificial intelligence (AI) engine 322.

Provided examples of applications 126 include banking application 312, shopping application 314, web browser application 316, audio/video application 318, and message application 320. Banking application 312 includes program code that is executed by processor 102 to configure electronic device 100 to access banking services provided by a bank or other financial institution, such as a credit card company, online payment service, etc. Shopping application 314 includes program code that is executed by processor 102 to configure electronic device 100 to access websites to browse and buy products or services from a retailer or service provider. Web browser application 316 includes program code that is executed by processor 102 to configure electronic device 100 to access various websites of the Internet. Audio/video communication application 318 includes program code that is executed by processor 102 to configure electronic device 100 to enable an audio/video communication session with other electronic devices. Audio/video communication application 318 includes a call access function 318A and a dial-pad function 318B. Call access function 318A can enable access to an incoming audio/video call and dial-pad function 318B can enable a dial-pad to be presented on display 130. Message application 320 includes program code that is executed by processor 102 to configure electronic device 100 to enable text and multi-media messaging with other electronic devices. While five applications are shown, applications 126 can include more or fewer than five applications.

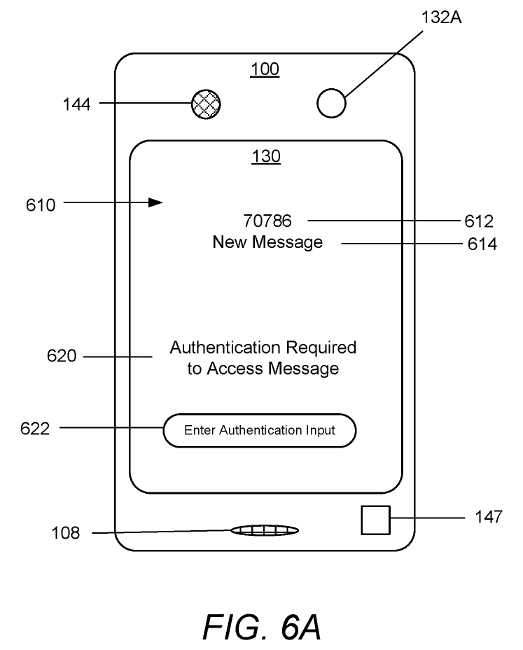

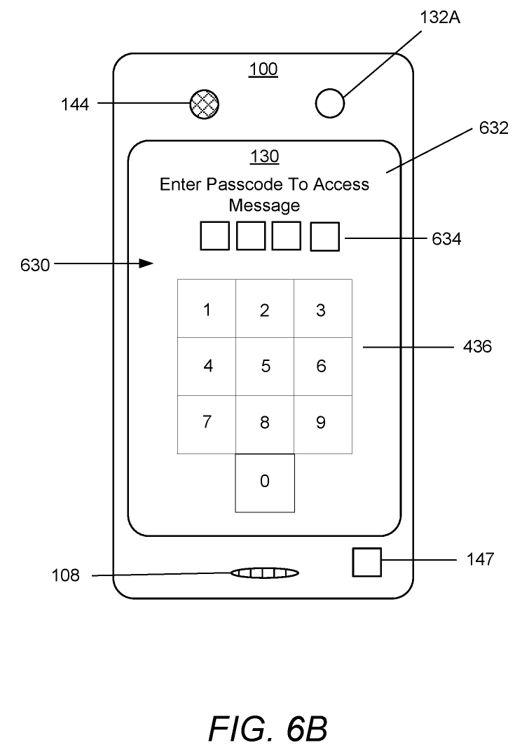

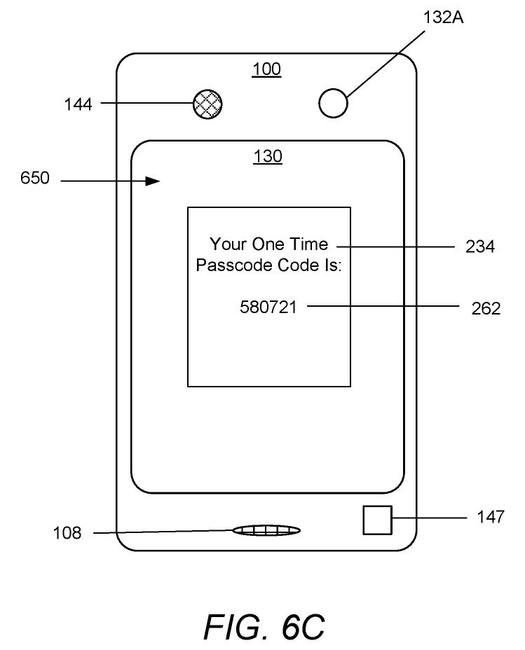

Security module 128 includes program code that is executed by processor 102, which configures electronic device 100 to perform the various features of the present disclosure. In one or more embodiments, security module 128 configures electronic device 100 to authenticate a user before access is granted to at least one incoming communication 220. In one or more embodiments, execution of security module 128 by processor 102 configures electronic device 100 to perform the processes presented in the flowcharts of FIGS. 6-8, as will be described below. Communication module 129 configures electronic device 100 to communicate and exchange data with other devices via WCS 142, and/or SRCD(s) 164, and/or wireless network 150 and/or WiFi router 196. AI engine 322 accelerates artificial intelligence, natural language processing (NLP), context evaluation (CE), and machine learning applications.

System memory 120 includes messages 340 and reference short codes 350. Messages 340 are received from another electronic device (e.g., second electronic device 184) or from another computer system 180, such as a server accessible via a network. In one embodiment messages 340 can be text or multi-media messages. Messages 340 include message A 342 and message B 344. Message A 342 includes a short code 342A and message B 344 includes a short code 344A. Short codes 342A and 344A are short digit-sequences that are used to address messages in the Multimedia Messaging System (MMS) and short message service (SMS) systems of mobile network operators. Short codes are unique to each type of operator. Some classes of short codes are used by multiple providers. In one example embodiment, a five or six digit short code corresponds to a message sent from a bank, business or government.

Reference short codes 350 are pre-determined short codes that are associated with either a specific message sender or a type of message sender. In one example embodiment, the short code 54380 corresponds to a message sent from a bank. Reference short codes 350 can be used to identify if the sender of a message is a business or government or if the sender is an individual.

System memory 120 includes authentication input 360, and reference authentication data 370. Authentication is the process of verifying that an individual is whom they claim to be. Authentication input 360 is input received by electronic device 100 during an authentication process. Authentication input 360 can include various types of input such as a passcode 362, a fingerprint image 364, a facial image 366, and a biometric identifier 368 such as voice or speech input. Passcode 362 can be input to electronic device 100 via touch screen interface 131. Fingerprint image 364 can be sensed by electronic device 100 via fingerprint sensor 147. Facial image 366 can be captured by electronic device 100 via at least one of front ICD’s 132A or 132B. Biometric identifier 368, such as voice or speech input, can be input to electronic device 100 via microphone 108.

Reference authentication data 370 is pre-established authentication data that are used to authenticate a user during an authentication process. Reference authentication data 370 can include various types of data such as a reference passcode 372, a reference fingerprint scan 374, a reference facial image 376, and a reference biometric identifier 378 such as a reference voice-print.

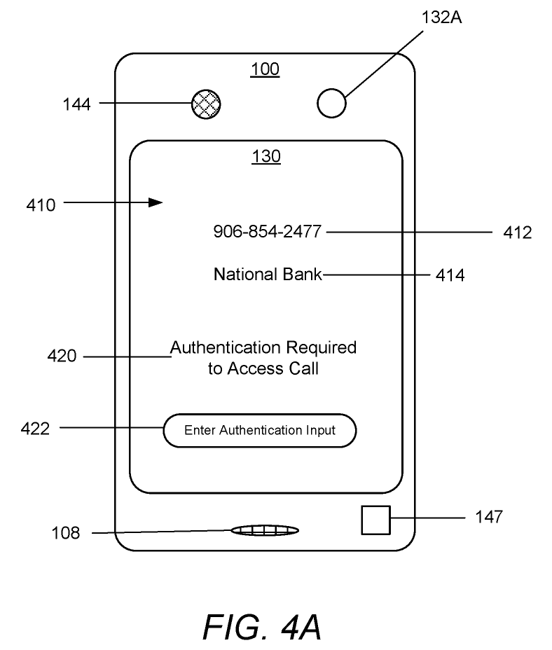

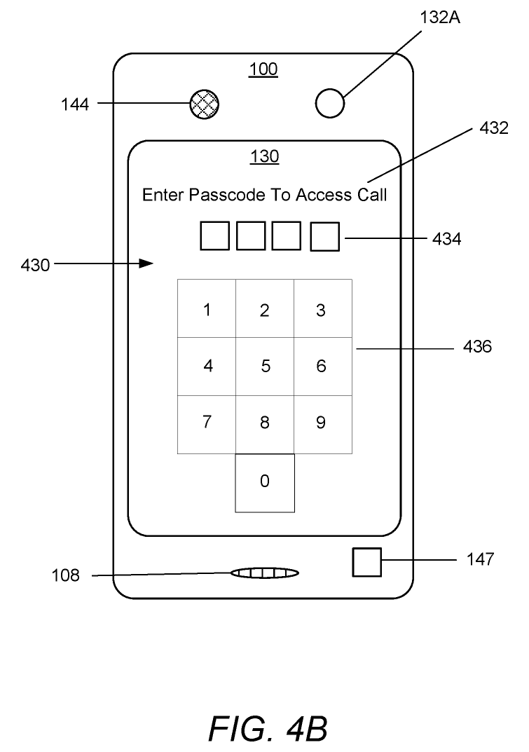

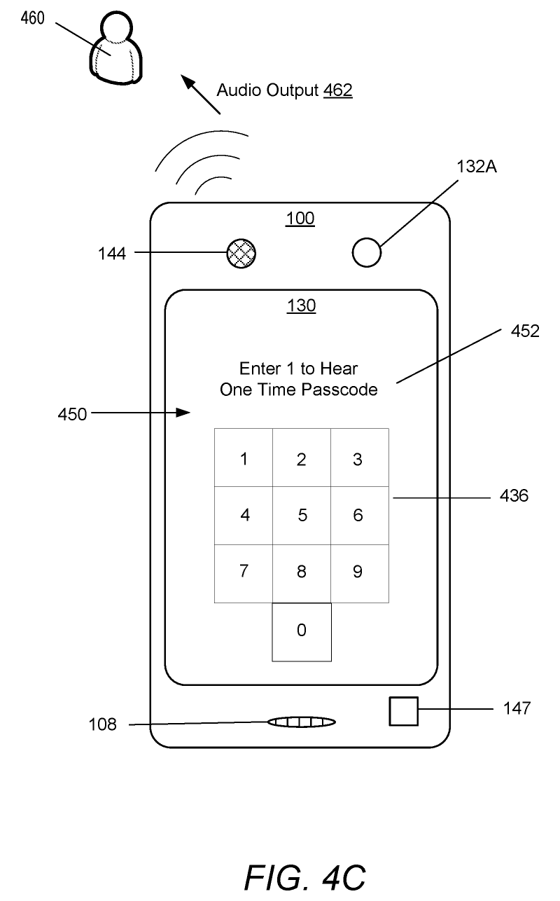

FIG. 4A illustrates an example incoming call graphical user interface (GUI) 410 presented on display 130 of electronic device 100 during the presentation/notification of an incoming call 230 or an incoming VOIP call 232. In one embodiment, presentation of incoming call GUI 410 on the device’s display can be triggered by receiving an incoming call 230 or an incoming VOIP call 232 to electronic device 100. When electronic device 100 detects an incoming call, electronic device 100 can generate an audible ring tone via speaker 144 and/or cause the electronic device to vibrate via vibration device 146 in order to alert a user to the incoming call. In one embodiment, when electronic device 100 detects an incoming call, electronic device 100 can identify if the incoming call is a “secure communication” that requires authentication of the device user before access is granted to the incoming call on the device. A secure communication is a communication that is intended only for an authorized recipient and is not intended to be accessed by other unauthorized users. In response to identifying that the incoming call is a secure communication that requires user authentication before access is granted, electronic device 100 disables access to the incoming call (i.e., a user cannot answer the call) until an authentication process is completed (i.e., the user enters or presents the correct authentication credential).

Incoming call GUI 410 includes caller number 412, caller identifier 414, prompt 420 for entry of an authentication input, and selectable enter authentication input option 422. Caller number 412 is the originating phone number of the incoming call. Caller identifier 414 is the name or organization associated with the caller number. Prompt 420 is a notification to a user that authentication is required in order to answer or view the incoming call 230 or incoming VOIP call 232. The selection of enter authentication input option 422 can trigger electronic device 100 to receive at least one type of authentication input 360. In one embodiment, electronic device 100 can receive fingerprint image 364 via fingerprint sensor 147, or facial image 366 via front ICD 132A, or biometric identifier 368 such as a voice-print via microphone 108.

FIG. 4B illustrates an example authentication GUI 430 presented on display 130 of electronic device 100 after user selection of enter authentication input option 422 (FIG. 4A). Selection of enter authentication input option 422 can trigger electronic device 100 to present authentication GUI 430 on display 130. Authentication GUI 430 includes a prompt 432 to enter passcode 362 to access the incoming call, a passcode entry window 434, and a dial-pad 436 for a user to use to input the passcode. A user can input passcode 362 using dial-pad 436 in order to access the incoming call. Electronic device 100 can receive passcode 362 via dial-pad 436.

Referring to FIG. 4C, an example call GUI 450 is shown. Call GUI 450 is presented on display 130 of electronic device 100 after a user has been authenticated. Call GUI 450 includes a message 452 to enter “1” on the dial-pad 436 to hear the one time passcode (OTP) 262. A user can input “1” using dial-pad 436 to hear OTP 262 via speaker 144. Electronic device 100 can present OTP 262 to a user 460 via audio output 462 played via speaker 144.

According to one aspect of the disclosure, electronic device 100 can detect a trigger indicative of the at least one incoming communication (e.g. incoming communication(s) 220) being received by the electronic device. In response to detecting the trigger, electronic device 100 identifies if the incoming communication(s) 220 is a secure communication that requires authentication before access is granted to the incoming communication(s). In response to identifying that the incoming communication(s) is a secure communication that requires authentication before access is granted, electronic device 100 disables access to the incoming communication(s) 220 and generates and presents a prompt 420 for entry of an authentication input. In response to receiving the authentication input, electronic device 100 determines if the received authentication input 360 substantially matches reference authentication data 370. In response to determining that the authentication input 360 substantially matches the reference authentication data 370, electronic device 100 enables access to the incoming communication(s).

According to another aspect of the disclosure, electronic device 100 can present authentication GUI 430 on display 130 comprising the prompt 420 for entry of the authentication input 360, and electronic device 100 can receive the authentication input via authentication GUI 430.

According to an additional aspect of the disclosure, the trigger indicative of an incoming communication comprises receiving an incoming call 230. Electronic device 100 detects a user attempt to answer the incoming call 230. Electronic device 100 generates and presents the prompt 420 for entry of the authentication input, in response to detecting the user attempt to answer the incoming call. Electronic device 100 disables access to the audio/video stream of the incoming call until receipt of a correct authentication input (i.e., an authentication input that matches reference authentication data370). According to yet another aspect of the disclosure, to disable access to the audio/video stream of the incoming call, electronic device 100 disables access to dial-pad 436.

According to one more aspect of the disclosure, electronic device 100 can be in a locked state prior to detecting the trigger indicative of the at least one incoming communication 220 being received by electronic device 100. Electronic device 100 can trigger the prompt 420 for entry of authentication input 360, based on receipt of the at least one incoming communication 220 while electronic device 100 is in the locked state. Device unlock authentication process is then required to gain access to the incoming communication. In one embodiment, a separate security code is utilized to obtain access to the incoming communication without unlocking the device.

According to another aspect of the disclosure, the trigger indicative of an incoming communication comprises receiving an incoming VOIP call 232. Electronic device 100 identifies a first application associated with the incoming VOIP call and determines if the first application is an audio-video application (e.g., audio/video application 318). In response to determining that the first application is an audio-video application, electronic device 100 disables a call-accept function or feature 318A of the audio-video application to prevent access to the incoming VOIP call 232. According to yet another aspect of the disclosure, after a user has been authenticated, electronic device 100 can re-enable the call-accept feature of the audio-video application to permit accepting and opening of the incoming VOIP call.

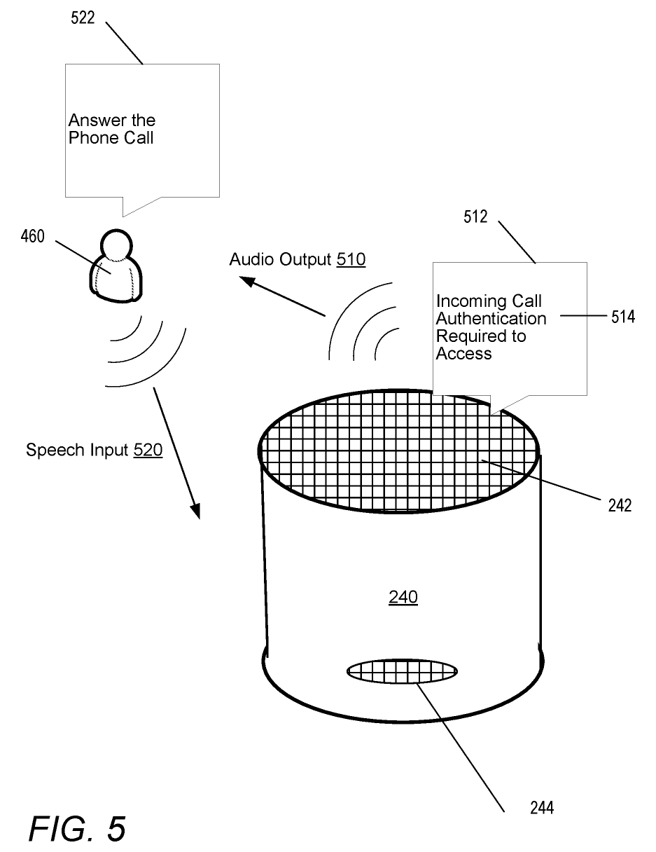

Referring to FIG. 5, smart speaker 240 is shown receiving an incoming call 230 or an incoming VOIP call 232. Smart speaker 240 can provide audio alert or output 510 via speaker 242 when an incoming call is received. The audio output 510 includes audio content 512. In one embodiment, audio content 512 can include a prompt 514 to enter authentication input such as “incoming call, authentication required to access”. A user 460 can respond to the audio output 510 with a voice or speech input 520. In one embodiment, speech input 510 can have speech content 522 of “answer the phone call”. Smart speaker 240 can detect the voice or speech input 520 via microphone 244 and authenticate user 460 using voice recognition. Smart speaker 240 can determine if the authentication input 360 (e.g., speech input 520) matches a reference authentication input (e.g., reference biometric ID 378) such as a reference voice-print. In response to determining that the speech input 520 matches reference biometric ID 378, smart speaker 240 can enable access to the incoming call.

According to one aspect of the disclosure, electronic device 100 presents an audio alert 510, via speaker 242, comprising the prompt 514 for entry of the authentication input 360 and receives authentication input 360 (e.g., speech input 520) via microphone 108.

FIG. 6A illustrates an example incoming message graphical user interface (GUI) 610 presented on display 130 of electronic device 100 during the presentation of an incoming message 234. In one embodiment, presentation of incoming message GUI 610 can be triggered by receiving an incoming message 234 to electronic device 100. In one embodiment, when electronic device 100 detects an incoming message, electronic device 100 can identify if the incoming message is a secure message that requires authentication before access is granted to the incoming message. In response to identifying that the incoming message is a secure message that requires authentication before access is granted, electronic device 100 disables access to the incoming message (i.e., a user cannot view the message) until an authentication process is completed.

Incoming message GUI 610 includes a notification 614 of the incoming message, a short code 612 associated with the sender of the message, prompt 620 for entry of an authentication input, and selectable enter authentication input option 622. Short code 612 is associated with either a specific message sender or a type of message sender. Prompt 620 is a notification to a user that authentication is required in order to view the incoming message 234. The selection of enter authentication input option 622 can trigger electronic device 100 to receive at least one type of authentication input 360. In one embodiment, electronic device 100 can receive fingerprint image 364 via fingerprint sensor 147, or facial image 366 via front ICD 132A, or biometric identifier 368, such as a voice-print, via microphone 108.

FIG. 6B illustrates an example graphical user interface (GUI) 630 presented on display 130 of electronic device 100 after selection of enter authentication input option 622 (FIG. 4A). Selection of enter authentication input option 622 can trigger electronic device 100 to present authentication GUI 630 on display 130. Authentication GUI 630 includes a prompt 632 to enter passcode 362 to access the incoming message, a passcode entry window 634, and a dial-pad 436 for a user to enter the passcode. A user can input passcode 362 using dial-pad 436 in order to access the incoming message. Electronic device 100 can receive passcode 362 via dial-pad 436.

Referring to FIG. 6C, an example graphical user interface (GUI) 650 is shown. GUI 650 is presented on display 130 of electronic device 100 after a user has been authenticated. In the example, GUI 650 includes the incoming message 234 with a one-time passcode (OTP) 262 after the user has been authenticated.

According to one aspect of the disclosure, the trigger indicative of an incoming communication comprises receiving an incoming message 234. Electronic device 100 identifies a short code 612 associated with the incoming message. In response to identifying the short code 612, electronic device 100 determines if the short code is an identity verification short code. As utilized herein, an identity verification short code is a code, such as a sequence of numeric digits, embedded in a message header or sent along with a message/communication, that indicates to (and/or is interpreted by) the processor of the electronic device that authentication access to the device is required before the received/incoming communication or message is outputted or presented to the user. In response to determining that the short code is an identity verification short code, electronic device 100 withholds presenting the incoming message 234 and generates and presents prompt 620 for the authentication input.

Following, in response to receiving and determining that an authentication input 360 substantially matches the reference authentication data 370, electronic device 100 renders and present the incoming message 234 on display 130 or presents incoming message 234 audibly via speaker 144, if electronic device 100 is configured to provide audible presentation/output of text-based or audio incoming messages.

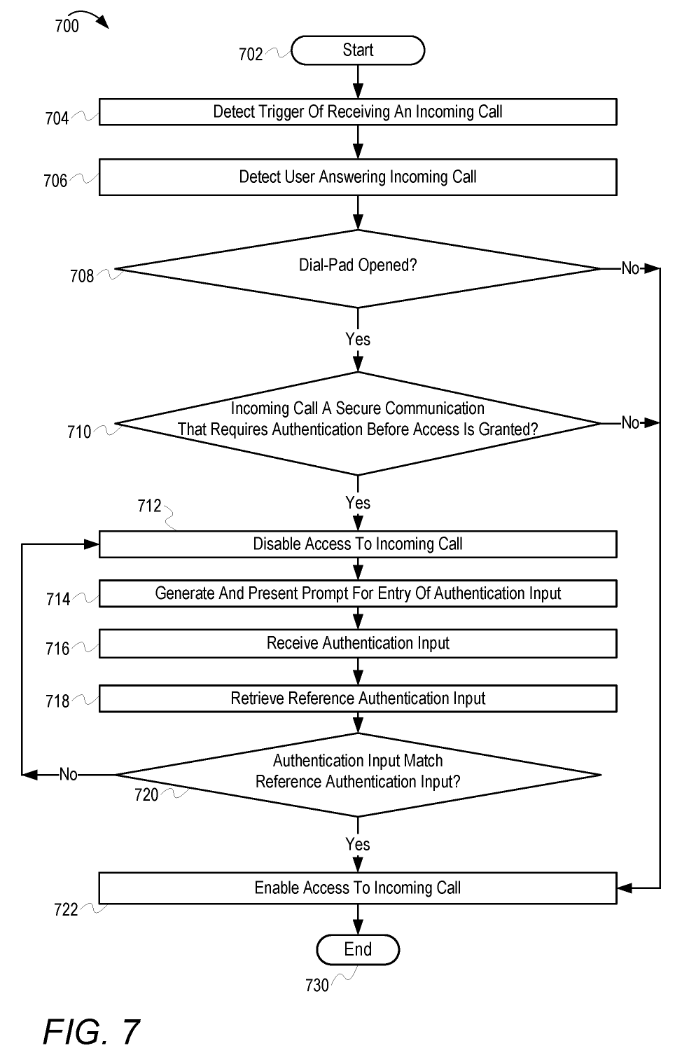

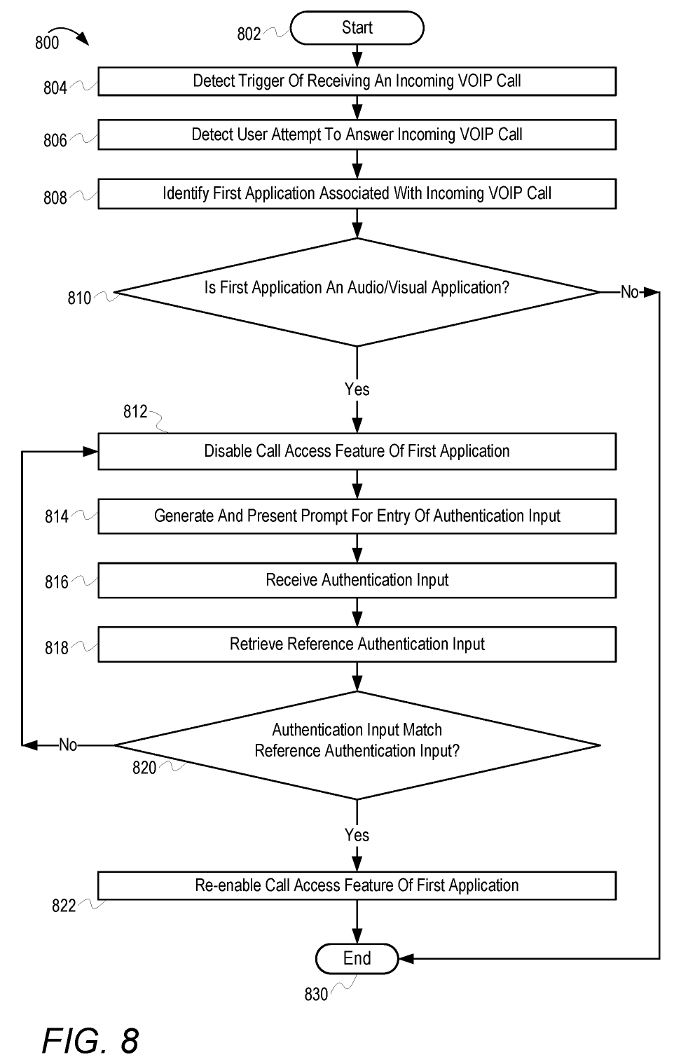

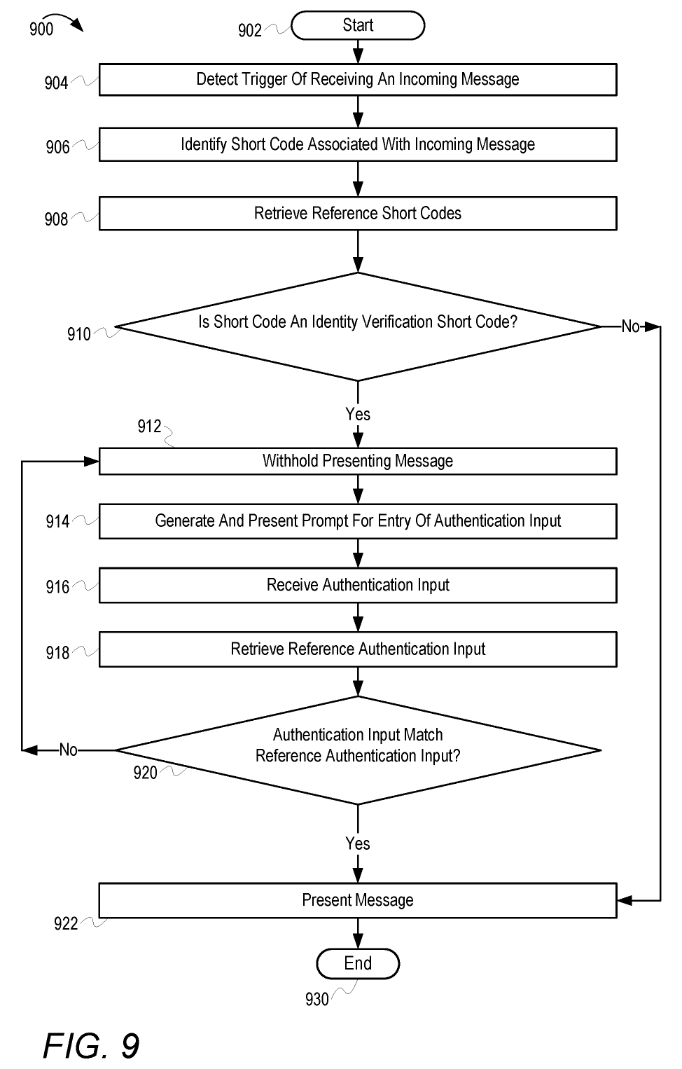

FIG. 7 depicts method 700 by which electronic device 100 detects a secure incoming call and authenticates a user before granting access to the incoming call. FIG. 8 depicts method 800 by which electronic device 100 detects a secure incoming VOIP call and authenticates a user before granting access to the incoming VOIP call. FIG. 9 depicts method 900 by which electronic device 100 detects a secure incoming message and authenticates a user before granting access to the incoming message.

The description of methods 700, 800, and 900 will be described with reference to the components and examples of FIGS. 1-6C. The operations depicted in FIGS. 7-9 can be performed by electronic device 100 or smart speaker 240 or any suitable electronic device that includes the one or more functional components of electronic device 100 that provide/enable the described features. One or more of the processes of the methods described in FIGS. 7-9 may be performed by processor 102 executing program code associated with security module 128 and configuring the electronic device to perform the various processes.

With specific reference to FIG. 7, method 700 begins at the start block 702. At block 704, method 700 includes detecting a trigger of receiving an incoming call 230 by electronic device 100. In response to detecting the trigger, method 700 includes detecting a user answering the call via a user selection on touch screen interface 131 or a user selection of at least one of buttons 107a-107n (block 706). Method 700 includes determining if dial-pad 436 has been opened via touch screen interface 131 (decision block 708). In one embodiment, dial-pad 436 can be used by a user to access a passcode of the incoming call, by entering a specific number to listen to the passcode. In response to determining that a user has not opened dial-pad 436, method 700 includes enabling access to the incoming call 230 (block 722). Method 700 ends at end block 730.

In response to determining that a user has opened dial-pad 436, method 700 includes identifying if the incoming call 230 is a secure communication that requires authentication before access is granted to the incoming call (decision block 710). In response to identifying that the incoming call 230 is not a secure communication that requires authentication before access is granted, method 700 includes enabling access to the incoming call 230 (block 722). Method 700 ends at end block 730.

In response to identifying that the incoming call 230 is a secure communication that requires authentication before access is granted, method 700 includes disabling access to the incoming call 230 (block 712). Method 700 includes generating and presenting a prompt 420 for entry of an authentication input (block 714). Method 700 includes receiving the authentication input 360 (block 716). In one embodiment, authentication input 360 can be at least one of a passcode, a fingerprint, a facial image, or a biometric ID.

In response to receiving the authentication input 360, method 700 includes retrieving reference authentication data 370 from system memory 120 (block 718) and determining if the received authentication input 360 substantially matches reference authentication data 370 (decision block 720). In response to determining that the authentication input 360 substantially matches the reference authentication data 370, method 700 includes enabling access to the incoming call 230 (block 722). Method 700 terminates at end block 730. In response to determining that the authentication input 360 does not substantially match the reference authentication data 370, method 700 returns to block 712 to continue disabling access to the incoming call.

FIG. 8 depicts method 800 by which electronic device 100 detects a secure incoming VOIP call and requires a user to authenticate before access is granted to the incoming VOIP call. With reference to FIG. 8 method 800 begins at the start block 802. At block 804, method 800 includes detecting a trigger of receiving an incoming VOIP call 232 by electronic device 100. In response to detecting the trigger, method 800 includes detecting a user answering the call via a user selection on touch screen interface 131 or a user selection of at least one of buttons 107a-107n (block 806). Method 800 includes identifying a first application (e.g. audio/video application 318) associated with the incoming VOIP call 232 (decision block 808).

Method 800 includes determining if the first application (e.g. audio/video application 318) is an audio/video application that enables access to an audio/video communication session of electronic device 100 (decision block 810). In response to determining that the first application (e.g. audio/video application 318) is not an audio/video application, method 800 ends at end block 830. In response to determining that the first application (e.g. audio/video application 318) is an audio/video application, method 800 includes disabling call access feature 318A of the first application (e.g. audio/video application 318) (block 812). In one embodiment, disabling call access feature 318A prevents user access to the incoming VOIP call.

Method 800 includes generating and presenting a prompt 420 for entry of an authentication input (block 814). Method 800 includes receiving the authentication input 360 (block 816). In one embodiment, authentication input 360 can be at least one of a passcode, a fingerprint, a facial image, or a biometric ID.

In response to receiving the authentication input 360, method 800 includes retrieving reference authentication data 370 from system memory 120 (block 818) and determining if the received authentication input 360 substantially matches reference authentication data 370 (decision block 820). In response to determining that the authentication input 360 substantially matches the reference authentication data 370, method 800 includes re-enabling the call access feature 318A of audio/video application 318 to access the incoming call 230 (block 822). Method 800 terminates at end block 830. In response to determining that the authentication input 360 does not substantially match the reference authentication data 370, method 800 returns to block 812 to continue disabling call access feature 318A of the first application (e.g. audio/video application 318).

FIG. 9 depicts method 900 by which electronic device 100 detects receipt of a secure incoming message and authenticates a user before access is granted to the incoming message. With reference to FIG. 9 method 900 begins at the start block 902. At block 904, method 900 includes detecting a trigger of receiving an incoming message (e.g., message A 342) by electronic device 100. In response to detecting the trigger, method 900 includes identifying a short code 342A associated with the incoming message A 342 (block 906). Method 900 includes retrieving reference short codes 350 (block 908).

Method 900 includes determining if the short code 342A is an identity verification short code (decision block 910). In response to determining that the short code 342A is not an identity verification short code, method 900 includes presenting incoming message A 342 (block 922). Method 900 then ends at end block 930. In response to determining that the short code 342A is an identity verification short code, method 900 includes withholding presentation of the incoming message A 342 (block 912).

Method 900 includes generating and presenting a prompt 420 for entry of an authentication input (block 914). Method 900 includes receiving the authentication input 360 (block 916) and retrieving reference authentication data 370 from system memory 120 (block 918). In one embodiment, authentication input 360 can be at least one of a passcode, a fingerprint, a facial image, or a biometric ID.

In response to receiving the authentication input 360, method 900 includes determining if the received authentication input 360 substantially matches reference authentication data 370 (decision block 920). In response to determining that the authentication input 360 substantially matches the reference authentication data 370, method 900 includes presenting incoming message A 342 (block 922). In one embodiment, message A 342 can be presented on display 130. In another embodiment, message A 342 can be presented via audio output of speaker 144 of electronic device 100 or speaker 242 of smart speaker 240. Method 900 terminates at end block 930. In response to determining that the authentication input 360 does not substantially match the reference authentication data 370, method 900 returns to block 912 to continue withholding presentation of the incoming message.

The disclosure enables authentication of a user before granting access to at least one incoming communication that is received via an electronic device. The disclosure prevents unauthorized access by an unauthorized user to contents of an incoming call/communication. The incoming communication can be an incoming phone call, an incoming VOIP call or an incoming message. The disclosure enables enhanced security for an electronic device regardless of whether the electronic device is in a locked or an unlocked state.

In the above-described methods of FIGS. 7-9, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms "tangible" and "non-transitory" are intended to describe a computer-readable storage medium (or "memory") excluding propagating electromagnetic signals; but are not intended to otherwise limit the type of physical computer-readable storage device that is encompassed by the phrase “computer-readable medium” or memory. For instance, the terms "non-transitory computer readable medium" or "tangible memory" are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem;
a memory having stored thereon a security module for authenticating a user before access is granted to at least one incoming communication; and
at least one processor communicatively coupled to the communications subsystem and the memory and which executes program code of the security module, the at least one processor configured to cause the electronic device to:
detect a trigger indicative of the at least one incoming communication being received by the electronic device;
in response to detecting the trigger, identify if the at least one incoming communication is a secure communication that requires authentication before access is granted to the at least one incoming communication; and
in response to identifying that the at least one incoming communication is a secure communication that requires authentication before access is granted, disable access to the at least one incoming communication;
generate and present a prompt for entry of an authentication input;
in response to receiving the authentication input, determine if the received authentication input substantially matches a reference authentication input; and
in response to determining that the authentication input substantially matches the reference authentication input, enable access to the at least one incoming communication.

2. The electronic device of claim 1, further comprising:
a display communicatively coupled to the at least one processor; and
to generate and present the prompt, the at least one processor is further configured to:
present an authentication graphical user interface (GUI) on the display comprising the prompt for entry of the authentication input; and
receive the authentication input.

3. The electronic device of claim 2, wherein the trigger comprises receiving an incoming call, and the at least one processor is further configured to:
detect a user attempt to answer the incoming call;
generate and present the prompt for entry of the authentication input in response to detecting the user attempt to answer the incoming call; and
disable access to the audio/video stream of the incoming call until receipt of a correct authentication input.

4. The electronic device of claim 3, wherein to disable access to the audio/video stream of the incoming call, the at least one processor is further configured to:
disable access to a dial-pad.

5. The electronic device of claim 1, further comprising:
a speaker communicatively coupled to the at least one processor; and
to generate and present the prompt, the at least one processor is further configured to:
present an audio alert on the speaker comprising the prompt for entry of the authentication input; and
receive the authentication input.

6. The electronic device of claim 1, wherein the trigger comprises receiving an incoming message, and the at least one processor is further configured to:
identify a first short code associated with the incoming message;
in response to identifying the first short code, determine if the first short code is an identity verification short code; and
in response to determining that the first short code is an identity verification short code:
withhold presenting the incoming message; and
generate and present the prompt for the authentication input.

7. The electronic device of claim 6, wherein to enable access to the at least one incoming communication, the at least one processor is further configured to:
render and present the incoming message.

8. The electronic device of claim 1, wherein the trigger comprises receiving an incoming voice over internet protocol (VOIP) call, and the at least one processor is further configured to:
identify a first application associated with the incoming VOIP call;
determine if the first application is an audio-video application; and
in response to determining that the first application is an audio-video application, disable a call-accept feature of the audio-video application to prevent access to the incoming VOIP call.

9. The electronic device of claim 8, wherein to enable access to the at least one incoming communication, the at least one processor is further configured to:
re-enable the call-accept feature of the audio-video application to permit accepting and opening of the incoming VOIP call.

10. The electronic device of claim 1, wherein the electronic device is in a locked state prior to detecting the trigger indicative of the at least one incoming communication being received by the electronic device and the processor is configured to trigger the prompt for entry of the authentication input, based on receipt of the at least one incoming communication while the electronic device is in the locked state.

11. A method comprising:
detecting, via at least one processor of an electronic device, a trigger indicative of the at least one incoming communication being received by the electronic device;
in response to detecting the trigger, identifying if the at least one incoming communication is a secure communication that requires authentication before access is granted to the at least one incoming communication; and
in response to identifying that the at least one incoming communication is a secure communication that requires authentication before access is granted, disabling access to the at least one incoming communication;
generating and presenting a prompt for entry of an authentication input;
in response to receiving the authentication input, determining if the received authentication input substantially matches a reference authentication input; and
in response to determining that the authentication input substantially matches the reference authentication input, enabling access to the at least one incoming communication.

12. The method of claim 11, wherein to generate and present the prompt, the method further comprises:
presenting an authentication graphical user interface (GUI) on a display comprising the prompt for entry of the authentication input; and
receiving the authentication input.

13. The method of claim 12, wherein the trigger comprises receiving an incoming call, and the method further comprises:
detecting a user attempt to answer the incoming call;
generating and presenting the prompt for entry of the authentication input, in response to detecting the user attempt to answer the incoming call;
receiving the authentication input; and
disabling access to the audio/video stream of the incoming call until receipt of a correct authentication input.

14. The method of claim 13, wherein to disable access to the audio/video stream of the incoming call, the method further comprises:
disabling access to a dial-pad.

15. The method of claim 11, further comprising:
presenting an audio alert comprising the prompt for entry of the authentication input; and
receiving the authentication input.

16. The method of claim 13, wherein the trigger comprises receiving an incoming message, and the method further comprises:
identifying a first short code associated with the incoming message;
in response to identifying the first short code, determining if the first short code is an identity verification short code; and
in response to determining that the first short code is an identity verification short code:
withholding presenting the incoming message; and
generating and presenting a prompt for the authentication input.

17. The method of claim 16, wherein to enable access to the at least one incoming communication, the method further comprises:
rendering and presenting the incoming message.

18. The method of claim 11, wherein the trigger comprises receiving an incoming voice over internet protocol (VOIP) call, and the method further comprises:
identifying a first application associated with the incoming VOIP call;
determining if the first application is an audio-video application;
in response to determining that the first application is an audio-video application, disabling a call-accept feature of the audio-video application to prevent access to the incoming VOIP call; and
presenting, on a display, an authentication graphical user interface (GUI) including a prompt for the authentication input.

19. The method of claim 18, wherein to enable access to the at least one incoming communication, the method further comprises:
re-enabling the call-accept feature of the audio-video application to permit accepting and opening of the incoming VOIP call.

20. A computer program product comprising:
a computer readable storage device having stored thereon program code which, when executed by at least one processor of an electronic device having a communications subsystem, configures the electronic device to complete the functionality of:
detecting a trigger indicative of the at least one incoming communication being received by the electronic device;
in response to detecting the trigger, identifying if the at least one incoming communication is a secure communication that requires authentication before access is granted to the at least one incoming communication; and
in response to identifying that the at least one incoming communication is a secure communication that requires authentication before access is granted, disabling access to the at least one incoming communication;
generating and presenting a prompt for entry of an authentication input;
in response to receiving the authentication input, determining if the received authentication input substantially matches a reference authentication input; and
in response to determining that the authentication input substantially matches the reference authentication input, enabling access to the at least one incoming communication.
